(19) United States
(12) Patent Application Publication
(10) Pub. No.: US 2022/0386302 A1
(43) Pub. Date: Dec. 1, 2022

(54) HIERARCHICAL SCHEDULING FOR RADIO ACCESS NETWORK

(71) Applicant: Microsoft Technology Licensing, LLC, Redmond, WA (US)

(72) Inventors: Bozidar RADUNOVIC, Cambridge (GB); Xenofon FOUKAS, Cambridge (GB); Manikanta KOTARU, Kenmore, WA (US); Anuj KALIA, Newcastle, WA (US)

(73) Assignee: Microsoft Technology Licensing, LLC, Redmond, WA (US)

(21) Appl. No.: 17/333,158

(22) Filed: May 28, 2021

(51) Int. Cl. H04W 72/04; H04W 72/12; G06N 20/00

(52) U.S. Cl. CPC H04W 72/0433; H04W 72/1263; H04W 72/1226; G06N 20/00

(57) ABSTRACT

Aspects of the present disclosure relate to allocating RAN resources among RAN slices according to reinforcement learning techniques. For example, a network slice controller (NSC) may generate a RAN resource allocation and associated expected slice characteristics may be determined for each slice based on the RAN resource allocation. Resources of the RAN may be allocated accordingly, such that resulting actual slice characteristics may be observed and compared to the expected slice characteristics. A reward may be generated for the resource allocation, for example based on a difference between the expected and observed slice characteristics. RAN resource allocation and slice characteristic forecasting may be adapted according to such rewards. As a result, RAN resource allocation generation may improve, even in instances with changing or unknown network conditions. Thus, even when a local scheduler exhibits unknown behavior, differences between expected and observed slice characteristics may be used to tune resource allocation accordingly.

### BACKGROUND

Demand for integration between a cloud network and a radio access network (RAN) and/or a core network for wireless telecommunications has rapidly increased. The RAN provides wireless connectivity to mobile computing devices by converting radio frequency signals into data bits and vice versa. The core network coordinates among various parts of the RAN and provides connectivity to a packet-based network (e.g., the Internet). Traditional wireless telecommunications deployed servers with hardware that was specialized to particular types of processing and was typically built with a capacity to accommodate an estimated peak load of the network traffic. Use of cloud network technology, particularly virtual server technologies, has enabled decoupling of at least some wireless data processing from specialized hardware onto general-purpose servers. The general-purpose servers, combined with accelerators and the virtualization technologies, are able to dynamically change resource usage based on non-real-time and near real-time network demands.

With the advent of 5G, which is a system of mobile communications that improved upon aspects of the previous 4G system (reduced latency, increased bandwidth, etc.), the scope of mobile networks has increased to provide a broad range of wireless services delivered across multiple platforms and multi-layer networks. 5G specifications outline a host of performance requirements related to bandwidth, peak data rate, energy efficiency, reliability, latency (both user-plane and control-plane latency), traffic capacity, etc. To meet these requirements, the RAN architecture has expanded. For instance, Multi-Access Edge Computing (MEC) brings applications from centralized datacenters to the network edge, closer to end users. MEC provides low latency, high bandwidth, and real-time access to RAN information. Distributing computing power enables the high volume of 5G devices and facilitates disaggregated, virtual RANs to create additional access points. Network Function Virtualization (NFV) replaces network functions like firewalls, load balancers, and routers with virtualized instances that run as software. Enhanced Common Public Radio Interface (eCPRI) can be used, for instance, for the front-haul interface of a cloud RAN (e.g., for the real-time processing by the distributed unit (DU)).

A wireless telecommunication network is based on physical and geographical constraints. For example, cell towers, which provide cellular wireless coverage areas for mobile devices (e.g., smartphones), need to be physically distributed. Switches and servers, which process radio signals from cell towers into electrical or optical signals, need to be physically co-located or within a geographic range of each cell tower. The switches and the RAN servers need to process and route the cellular data traffic in real-time. Further, a RAN may comprise multiple “slices,” where each slice has associated service-level guarantees and components of the RAN are configured to process traffic for such slices accordingly. For example, a first slice may be a low-latency communication network (e.g., for substantially real-time processing), while a second slice may be a high-throughput communication network (e.g., for mobile broadband). Accordingly, traffic and associated processing for each slice may be handled by the RAN so as to maintain such service-level guarantees, for example on a statistical basis.

However, allocating resources of the RAN to maintain the service-level guarantees of each associated slice may be difficult, especially in instances where the behavior of certain components of the RAN is not known, not configurable, or is otherwise opaque. For example, each slice of a RAN may have a local scheduler that manages the logical resources of the slice (e.g., as may be allocated from the physical RAN resources). However, the scheduling technique used by a local scheduler may not be configurable or may not have information that is available for RAN resource allocation. In such instances, resources of the RAN may be allocated sub-optimally and/or service-level guarantees may not be maintained, among other detriments.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

According to the present disclosure, the above and other issues are resolved by allocating RAN resources among RAN slices according to reinforcement learning techniques. For example, a network slice controller (NSC) may generate a RAN resource allocation and associated expected slice characteristics (e.g., latency, available computational resources, a bit/packet error rate, associated energy consumption, or throughput) may be determined for each slice based on the generated RAN resource allocation. The generated RAN resource allocation may be implemented by the RAN so as to allocate RAN resources among slices of the RAN accordingly.

Resulting actual slice characteristics may be observed and compared to the expected slice characteristics, such that a reward may be generated (e.g., based on a difference between the expected and observed slice characteristics). RAN resource allocation and slice characteristic forecasting may be adapted according to rewards that are incurred by the NSC. As a result, RAN resource allocation generation may improve, even in instances with changing or unknown network conditions. Thus, even when a local scheduler exhibits unknown behavior, differences between expected and observed slice characteristics may be used to tune the operation of the NSC (e.g., slice characteristic estimation and RAN resource allocation) based on observed RAN behavior and taking into account information regarding varying wireless channel conditions and traffic demands.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system in which a hierarchical scheduler for allocating RAN resources may be used in accordance to aspects of the present disclosure.

FIG. 2 illustrates an example of a far-edge data center of a RAN in accordance with aspects of the present disclosure.

FIG. 3 illustrates examples of a RAN server in accordance with aspects of the present disclosure.

FIG. 4 illustrates a system depicting aspects of hierarchical network scheduling for a RAN.

FIG. 5 illustrates an overview of an example method for allocating RAN resources according to the reinforcement learning techniques described herein.

FIG. 6 is a block diagram illustrating example physical components of a computing device with which aspects of the disclosure may be practiced.

FIG. 7A is a simplified diagram of a mobile computing device with which aspects of the present disclosure may be practiced.

FIG. 7B is another simplified block diagram of a mobile computing device with which aspects of the present disclosure may be practiced.

### DETAILED DESCRIPTION

Various aspects of the disclosure are described more fully below with reference to the accompanying drawings, which form a part hereof, and which show specific example aspects. However, different aspects of the disclosure may be implemented in many different ways and should not be construed as limited to the aspects set forth herein; rather, these aspects are provided so that this disclosure will be thorough and complete, and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

A mobile wireless telecommunication network may use a cloud service for implementing a RAN. In this case, the cloud service connects cell towers, with which mobile devices (e.g., smartphones) connect, to the public network (e.g., the Internet) and/or private networks. The cloud service provides virtual servers and other computing resources for dynamically scaling the computing capacity as needed based on the volume of data traffic. In aspects, a cloud RAN infrastructure represents an implementation of cloud services for the RAN. In contrast to a typical cloud service, the cloud RAN infrastructure includes geographical and physical constraints as well as latency constraints imposed by RAN standards. The cloud RAN includes connection to at least one cell tower associated with a Radio Unit (RU) and cloud servers associated with one or more of a Distributed Unit (DU), a Central Unit (CU), and a RAN Intelligent Controller (RIC). The cell tower is in the field, where mobile devices connect over wireless cellular communications, and the RU of the cell tower connects to a DU of a RAN server at a far-edge data center. To enable real-time processing of RAN data traffic, the far-edge data center is relatively close (e.g., a few kilometers) to the cell tower. The DU is associated with switches and one or more RAN servers. The switches and the RAN server(s) associated with the DU process data in a series of operations or partitions associated with at least layer one (i.e., the physical layer) of the Open Systems Interconnection (OSI) model.

In examples, a RAN comprises multiple slices that are each used by a respective set of devices. The RAN components described herein may be allocated among the slices, thereby forming one or more logical networks using the physical resources of the RAN. A network slice controller (NSC) may be used to manage resource allocation. As an example, the network slice controller may map physical RAN resources into multiple sets of logical RAN resources, such that each slice utilizes its respective set of logical RAN resources. Example RAN resources include, but are not limited to, resource blocks, time slots, numerology, and/or a number of multiple-input and multiple-output (MIMO) layers for each slice of the RAN. For example, physical RAN resources may be allocated among slices according to service-level guarantees associated with the slices, such that each slice exhibits a requested set of characteristics (e.g., latency, a bit/packet error rate, associated energy consumption, or throughput). In some instances, resources may be allocated to meet service-level guarantees on a statistical basis, where one or more characteristics of a slice may vary over time and exhibit a specified variance and/or specified average for a predetermined period of time according to an associated service-level guarantee.

However, resource allocation may be difficult in instances where there are components of the RAN that are not configurable and/or in communication with an NSC of the RAN. Accordingly, the NSC may be unable to meet service-level guarantees as a result of the potentially unknown and/or un-configurable nature of such components. As an example, a slice may comprise a medium access control (MAC) scheduler (also be referred to herein as a local scheduler) that manages logical resources of the slice. For example, the MAC scheduler may divide logical radio resources among the set of computing devices associated with the slice, for example according to a round robin or proportional fairness algorithm, among other scheduling techniques. However, absent an indication from the MAC scheduler or control over the behavior over the MAC scheduler, the NSC may allocate RAN resources incorrectly (e.g., contrary to how resources could have been allocated were such information or control available), which may cause the behavior of one or more slices to differ from associated service-level guarantees.

As discussed in more detail below, the present disclosure relates to hierarchical scheduling for a RAN. In examples, reinforcement learning techniques are used by an NSC to allocate RAN resources according to network conditions. In the context of reinforcement learning, the NSC may take the action of allocating RAN resources, after which a reward may be accrued, where the reward is the difference between expected slice characteristics (e.g., based on the RAN resource allocation) and observed slice characteristics resulting from the RAN resource allocation. Accordingly, the NSC may generate a subsequent RAN resource allocation based on the incurred reward and expected slice characteristics (e.g., based on historical slice characteristic information) for the RAN, such that RAN resource allocation is responsive to changing network conditions even in instances where behavior of RAN resources is opaque to the NSC.

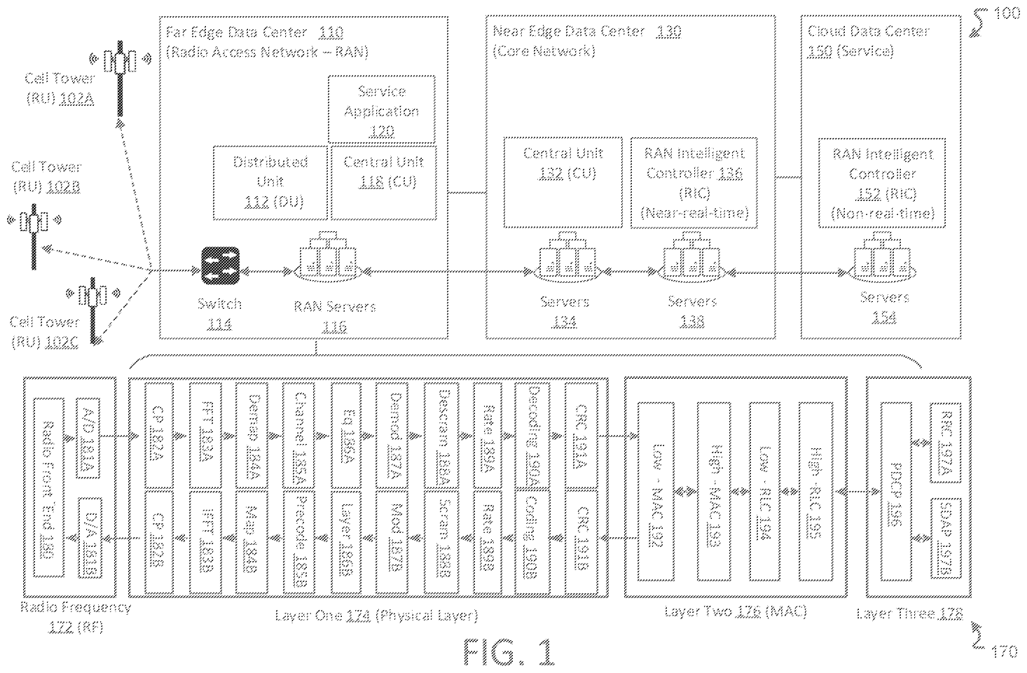

FIG. 1 illustrates an overview of an example system 100 in which a hierarchical scheduler for allocating RAN resources may be used in accordance with the aspects of the present disclosure. Cell towers 102A-C transmit and receive wireless communications with mobile computing devices (e.g., smartphones) over a radio access network (RAN). The example system 100 further includes far-edge data center 110 (switches, RAN servers), near-edge data center 130 (core network servers), and cloud data center 150 (cloud services). In aspects, the example system 100 corresponds to a cloud RAN infrastructure for a mobile wireless telecommunication network.

The far-edge data center 110 is a data center that is part of the cloud RAN, which includes distributed unit 112 (DU), central unit 118 (CU), and service application 120. In aspects, the far-edge data center 110 enables cloud integration with a radio access network (RAN). The far-edge data center 110 includes a switch 114 and RAN servers 116. The switch 114 and the RAN servers 116 process incoming data traffic and outgoing data traffic associated with layer one (the physical layer) 174 and at least a part of layer two (MAC) 176. In aspects, the far-edge data center 110 is generally geographically remote from the cloud data centers associated with the core network and cloud services. The remote site is in proximity to the cell towers. For example, the proximity in the present disclosure may be within a few kilometers or more. In aspects, the upstream data traffic corresponds to data flowing from the cell towers 102A-C to servers 154 in the cloud data center 150 (service) Similarly, the downstream data traffic corresponds to data flowing from the cloud data center 150 (service) to the cell towers.

The near-edge data center 130 includes a central unit 132 (CU) and RAN intelligent controller 136 (RIC) (near real-time processing, which may be less strictly time-sensitive than real-time processing). As illustrated, CU 132 is associated with servers 134 and RIC 136 is associated with servers 138. In aspects, the near-edge data center 130 is at a regional site of a private cloud service. For example, the regional site may be about tens of kilometers from the cell towers.

The cloud data center 150 (service) includes RIC 152 (non-real-time processing) associated with servers 154. For example, RIC 152 processes non-real-time service operations. In aspects, the cloud data center 150 may be at a central location in a cloud RAN infrastructure. For example, the central locations may be hundreds of kilometers from the cell towers.

In aspects, the far-edge data center 110, which is closer to the cell towers 102A-C than the cloud data center 150, provides real-time processing. In contrast, the cloud data center 150, which is the furthest from the cell towers 102A-C in the cloud RAN infrastructure, provides processing in a non-real-time manner.

The operational partitions 170 illustrate partitions processing data traffic in the RAN. For example, the partitions may correspond to operations associated with the OSI seven-layer model. In particular, a set of partitions associated with layer one 174 (the physical layer) is the lowest layer.

In aspects, prior to processing data at layer one 174 involves conversion of data associated with a radio frequency 172 (RF). For radio frequency 172 (RF) data processing, the radio front-end partition receives and sends data through the cell towers 102A-C to mobile computing devices over wireless communications. The A/D 181A converts analog data from the radio front-end to digital data for the upstream data traffic. The D/A 181B converts digital data into analog data for the downstream data traffic.

Partitions in layer one 174 (physical layer) may be associated with operations for converting coded symbols associated with a bit stream into a physical signal for transmission using communication media (e.g., a physical wire or radio). In aspects, the operational partitions of the physical layer may include, for processing upstream data traffic, CP 182A, FFT 183A, Demap 184A, Channel 185A, Eq 186A, Demod 187A, Descram 188A, Rate 189A, Decoding 190A, and CRC 191A. The physical layer may further include, for processing downstream data traffic, CRC 191B, Coding 190A, Rate 189B, Scram 188B, Mod 187B, Layer 186B, Precode 185B, Map 184B, iFFT 183B, and CP 182B.

Partitions in layer two 176 (media access control—MAC) may be associated with operations for transferring data frames between network hosts over a physical link. In aspects, partitions in layer two correspond to the network layer in the OSI seven-layer model. Low-MAC 192 is the lowest partition in the layer two 176. Other partitions above the Low-MAC 192 include, an ascending sequence of layers, High-MAC 193, Low-Radio Link Control (RLC) 194, and High-RLC 195.

Partitions in the layer three 178 may be associated with operations for forwarding data packets through routers. In aspects, layer three 178 corresponds to the network layer in the OSI seven-layer model. The partitions in layer three 178 may be associated with protocol-governed operations such as Packet Data Convergence Protocol 196 (PDCP), Radio Resource Control 197A (RRC) and Service Data Adaptation Protocol 197B (SDAP).

In aspects, a combination of DU 112 and CU 118 in the far-edge data center 110 may process partitions associated with layer one 174, layer two 176, and at least a part of layer three 178. In particular, respective servers of RAN servers 116 include CPUs and a variety of accelerators for processing data associated with one or more partitions of the operational partitions 170. Use of an accelerator for processing a partition reduces a workload on the CPU. In aspects, the accelerators are heterogeneous. Some accelerators include pre-programmed logic for performing specific operational partitions, e.g., LDPC decoding. Some other accelerators are programmable. Some accelerators provide fast table lookups, while some other accelerators provide fast bit operations (e.g., graphics and video data).

As described above, the RAN resources depicted by system 100 may be allocated to form multiple slices through which data from mobile devices are communicated. For example, RIC 152 may comprise an NSC that allocates RAN resources to form logical slices according to a set of service-level guarantees. As an example, RIC 152 may configure aspects of cell towers 102A-C, far-edge data center 110, and/or near-edge data center 130. In examples, RIC 136 may include the NSC rather than RIC 152, as the additional latency (e.g., between cloud data center 150 and other RAN resources) compared to that of near-edge data center 130 may introduce additional complexity and/or result in reduced performance. For example, an NSC at cloud data center 150 may generate RAN resource allocations further into the future (e.g., based on forecasted performance information further into the future) to account for the additional latency, which may result in reduced accuracy for expected slice characteristics and associated generated reward information.

An NSC (e.g., of RIC 136) may generate RAN resource allocations on a per-frame basis (e.g., every 10 milliseconds and/or at the same interval as performance information is generated), such that RAN resources may be reconfigured as specified by the NSC after each frame according to the reinforcement learning techniques described herein. In other examples, RAN resource allocations may be changed at a different frequency and/or may be generated in response to the occurrence of one or more events (e.g., based on determining a slice characteristic has exceeded a service-level guarantee or based on determining a number of devices of a slice has exceeded a predetermined threshold).

As will be appreciated, the various methods, devices, applications, features, etc., described with respect to FIG. 1 are not intended to limit the system 100 to being performed by the particular applications and features described. Accordingly, additional controller configurations may be used to practice the methods and systems herein and/or features and applications described may be excluded without departing from the methods and systems disclosed herein.

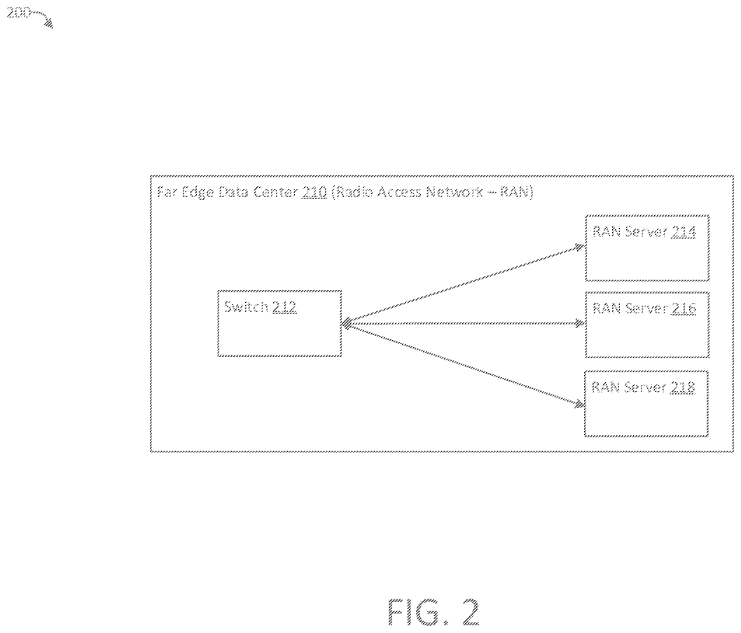

FIG. 2 illustrates an example of a far-edge data center 210. The far-edge data center 210 at least includes a switch 212 and RAN servers 214-216. The switch 212 connects the cell towers (e.g., the cell towers 102A-C as shown in FIG. 1) with one or more of the RAN servers 214-216 of the far-edge data center 210. In aspects, the switch 212 is a programmable switch, which loads a program that instructs switching data traffic to a particular RAN server. Additionally or alternatively, the program may monitor data traffic at the switch 212.

The respective RAN servers 214-218 include CPUs and heterogeneous accelerators. For example, the heterogeneous accelerators may include one or more of ASIC-based programmable switches, ASIC-based network interface controllers (NICs), neural processing unit (NPU)-based NICs, field-programmable gate array (FPGA)-based NICs, and the like. Other types of heterogeneous accelerators include graphical processing unit (GPU) and FPGA-based graphics accelerators.

In examples, switch 212 and servers 214-218 are RAN resources that may be allocated (e.g., by an NSC) for various slices of the RAN according to aspects described herein. For example, RAN servers 214, 216, and/or 218 may each process workloads of various slices of the RAN, according to service-level guarantees associated with the slice. As an example, a low-latency slice (e.g., for real-time Internet-of-things (IoT) processing) may be assigned more resources and/or resources at a higher priority as compared to a throughput slice (e.g., for mobile broadband) where latency is a comparatively lower priority.

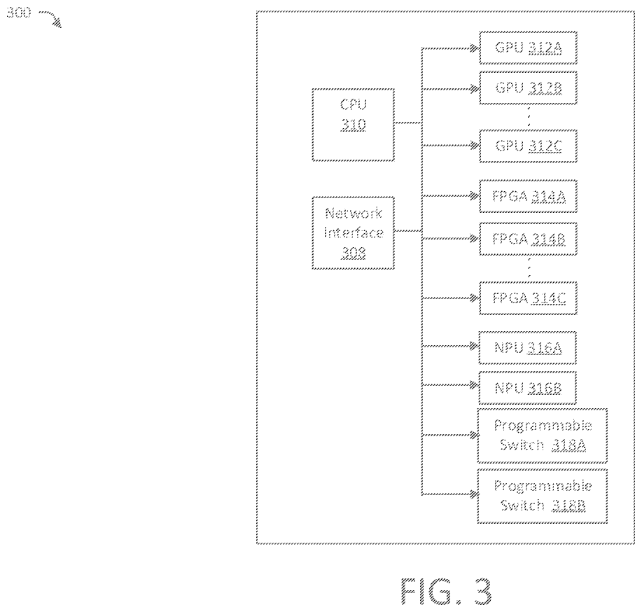

FIG. 3 illustrates examples of a RAN server in accordance with the aspects of the present disclosure. As illustrated, the RAN server 300 includes a CPU 310, a set of GPUs 312A-C, FPGAs 314A-C, NPUs 316A-B, programmable switches 318A-B, and a network interface 308. Some accelerators in the set of heterogeneous accelerators may be pre-programmed for performing a specific task. For example, the FPGA 314A may be pre-programmed with code for decoding/coding of data (e.g., Decoding 190A and Coding 190B as shown in FIG. 1) in layer one. Some other accelerators may be programmable by loading a code that performs operations associated with a partition or a service application. The network interface 308 interfaces the CPU 310, the heterogeneous accelerators, the cell towers, and the near-edge data center (core network) for connecting with the cloud infrastructure and other RAN servers and switches.

In aspects, the CPU 310 monitors a workload level of the CPU 310 and respective accelerators. The CPU 310, based on the workload level, may offload a task being processed by the CPU 310 to one or more of the accelerators with available processing resources. In aspects, the CPU 310 allocates a cluster of accelerators for processing a task. In examples, resources of RAN server 300 (e.g., CPU 310, a set of GPUs 312A-C, FPGAs 314A-C, NPUs 316A-B, programmable switches 318A-B, and a network interface 308) are configured by an NSC to allocate such resources among a set of slices of a RAN according to aspects of the present disclosure.

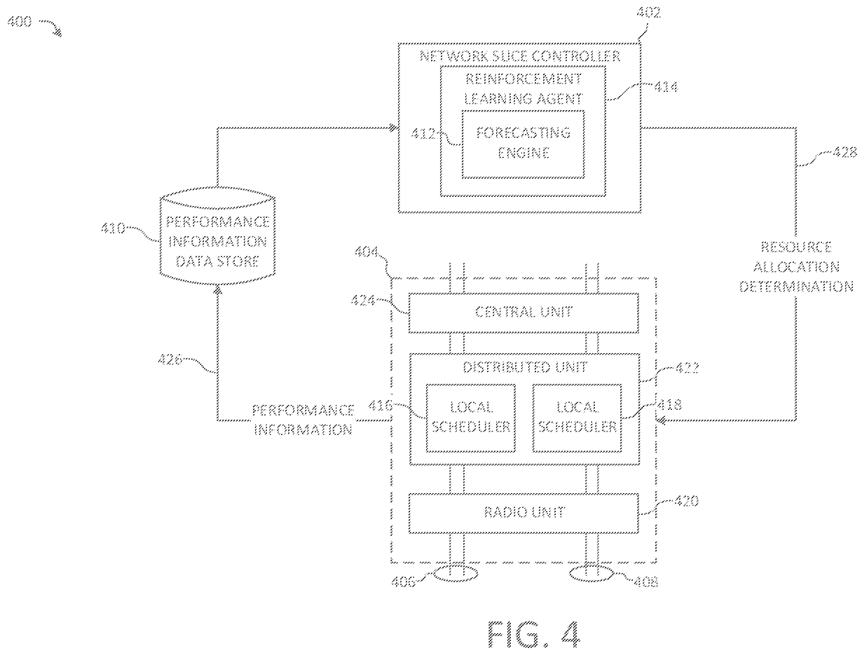

FIG. 4 illustrates a system 400 depicting aspects of hierarchical network scheduling for a RAN. As illustrated, system 400 comprises network slice controller (NSC) 400 and RAN components 404. As discussed above, network slice controller 402 may be implemented as part of a RAN intelligent controller (RIC), such as RIC 136 or RIC 152 discussed above with respect to system 100 in FIG. 1.

RAN components 404 are illustrated as comprising distributed unit 422, central unit 424, radio unit 420, and local schedulers 416 and 418. It will be appreciated that such components are provided as example RAN components and that any of a variety of additional or alternative RAN components may be used in other examples. Further, such aspects may be similar to those discussed above with respect to FIGS. 1-3 and are therefore not necessarily re-described below in detail. For example, RAN components 404 may have associated physical resources that are allocated according to aspects described herein, such as resource blocks, time slots, numerology, and/or a number of MIMO layers.

NSC 402 configures RAN components 404 to allocate associated RAN resources, thereby forming one or more logical slices using RAN components 404. As illustrated, slice 406 and slice 408 are logically implemented using the RAN components 404. For example, slice 406 may comprise resources of distributed unit 422, central unit 424, and radio unit 420 to facilitate network communications with a set of associated devices (not pictured). Similarly, slice 408 may comprise resources of distributed unit 422, central unit 424, and radio unit 420 to facilitate network communications with another set of associated devices (not pictured). It will be appreciated that each set of respective devices need not be mutually exclusive. Further, in some examples, slices 406 and 408 may be isolated from one another, such that devices associated with one slice are isolated from devices associated with another slice.

RAN components 404 are further illustrated as comprising local scheduler 416 and local scheduler 418, which are associated with slice 406 and slice 408, respectively. Local scheduler 416 may manage logical resources associated with slice 406, while local scheduler 418 may manage logical resources associated with slice 408. Thus, NSC 402 may configure RAN components 404 (e.g., associated with physical RAN resources) to form slices 406 and 408 that each have a resulting set of logical resources, such that local schedulers 416 and 418 allocate the logical resources of slices 406 and 408, respectively, among devices of each slice. For example, local schedulers 416 and 418 may allocate logical resources according to a round robin or proportional fairness algorithm, among other scheduling techniques. Thus, NSC 402 and local schedulers 416 and 418 may together operate to hierarchically schedule RAN resources.

System 400 is further illustrated as comprising performance information data store 410, which may store performance information associated with slices 406 and 408. In examples, performance information data store 410 may form part of a RIC, such as RIC 136 or RIC 152 discussed above with respect to system 100 in FIG. 1. Example performance information includes, but is not limited to, channel state information associated with radio communications with one or more associated devices (e.g., associated with radio unit 420), as well as slice-specific performance information and/or application behavior information of applications operating via slices 406 and/or 408, such as service application 120 discussed above with respect to FIG. 1. For example, performance information data store 410 may store historical wireless channel information for devices of slices 406 and/or 408 and traffic utilization for applications associated therewith.

In some instances, NSC 402 may be able to determine and/or configure at least a part of the resource allocation behavior of local scheduler 416 and/or local scheduler 418, such that a RAN resource allocation generated by NSC 402 may specify or otherwise account for the behavior of the local schedulers. However, in instances where local scheduler 416 and/or local scheduler 418 are opaque to NSC 402 (e.g., where logical resource allocation is not disclosed or is un-configurable), maintaining service-level guarantees associated with slices 406 and 408 may be difficult. For instance, a local scheduler may be manufactured by a different vendor, may implement different software application programming interfaces (APIs), or may be controlled by a different entity than that of other RAN components 404.

Accordingly, NSC 402 applies aspects of the reinforcement learning techniques described herein to generate RAN resource allocations based on performance information generated by RAN components 404 (e.g., as may be stored by performance information data store 410). As illustrated, NSC 402 comprises forecasting engine 412 and reinforcement learning agent 414. In examples, forecasting engine 412 processes historical performance information to generate expected slice characteristics for a future frame of the RAN. For example, reinforcement learning agent 414 may process historical performance information, associated expected slice characteristics (e.g., for a past frame associated with the historical performance information), and a RAN resource allocation to generate a reward for the historical performance information. The reward may be used to tune forecasting engine 412, such that subsequent expected slice characteristics are generated based on previous forecasting accuracy. Thus, reinforcement learning agent 414 may process historical information of performance information data store 410 to predict wireless channel and/or future traffic demands (e.g., by devices and/or applications associated with slices 406 and/or 408) to distribute RAN resources of RAN components 404 accordingly.

Thus, NSC 402 may generate a RAN resource allocation to meet a set of service-level guarantees for slices 406 and 408. The RAN resource allocation may have an associated set of expected slice characteristics (e.g., as may be generated by forecasting engine 412). The RAN resource allocation determination by NSC 402 is used to configure RAN components 404, as illustrated by arrow 428. Performance information may be generated by RAN components 404 as a result of the RAN resource allocation, as illustrated by arrow 426. Such performance information (e.g., now-historical performance information) may subsequently be processed by NSC 402 as described above.

Thus, system 400 illustrates a reinforcement learning process in which RAN resource allocations and resulting performance information are used to tune forecasted slice characteristics and resulting future RAN resource allocation determinations by NSC 402. Accordingly, the behavior of local schedulers 416 and/or 418 need not be known or controllable by NSC 402, but may instead be addressed as a result of the reinforcement learning techniques described herein.

It will be appreciated that while system 400 is illustrated as comprising two local schedulers 416 and 418, any number of local schedulers may be used. Similarly, it will be appreciated that similar techniques may be used to address potentially unknown behaviors of any of a variety of other components of a RAN.

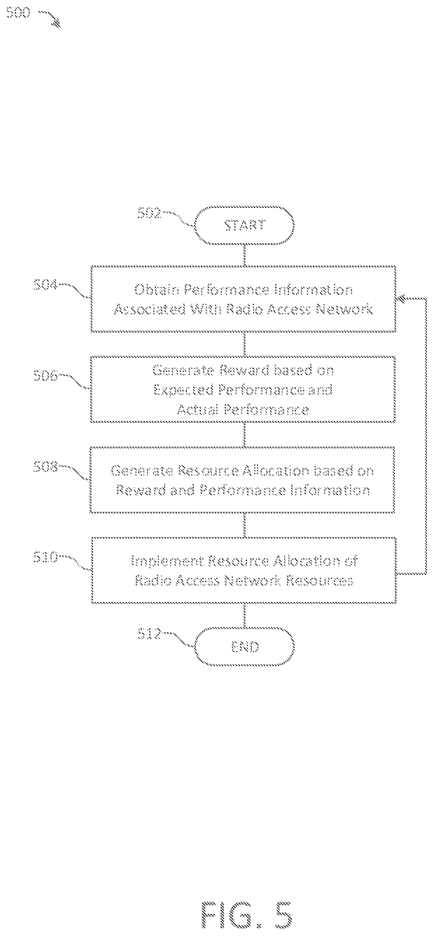

FIG. 5 illustrates an overview of an example method 500 for allocating RAN resources according to the reinforcement learning techniques described herein. A general order of the operations for the method 500 is shown in FIG. 5. Generally, the method 500 begins with start operation 502 and ends with end operation 512. The method 500 may include more or fewer steps or may arrange the order of the steps differently than those shown in FIG. 5. The method 500 can be executed as a set of computer-executable instructions executed by a computer system and encoded or stored on a computer readable medium. Further, the method 500 can be performed by gates or circuits associated with a processor, an ASIC, an FPGA, a SOC or other hardware device. Hereinafter, the method 500 shall be explained with reference to the systems, components, devices, modules, software, data structures, data characteristic representations, signaling diagrams, methods, etc., described in conjunction with FIGS. 1, 2, 3, 4, 6, and 7A-B. For example, aspects of method 500 may be performed by an NSC (e.g., NSC 402 in FIG. 4), as may be implemented by a RIC (e.g., RIC 136 or RIC 152 in FIG. 1).

Following start operation 502, the method 500 obtains performance information associated with a RAN at operation 504. For example, the performance information may be generated by resources of the RAN and may comprise channel state information, slice-specific performance information, and/or application behavior information. The performance information may be obtained from a performance information data store, such as performance information data store 410 discussed above with respect to FIG. 4. As discussed above, example performance information includes, but is not limited to, wireless channel information (e.g., channel state information and received signal strength information), data traffic (e.g., an amount of data an application requests to be served), and observed slice characteristics (e.g., throughput, bit/packet error rate, number of scheduled transmissions for energy consumption data estimation and latency information).

At operation 506, a reward is generated based on expected performance of the RAN and actual performance from the performance information obtained at operation 504. For example, the performance information may be associated with a historical frame of the RAN, where the RAN was configured according to a RAN resource allocation generated by an NSC. The RAN resource allocation may have associated expected slice characteristics (e.g., as may have been generated by a forecasting engine such as forecasting engine 412 in FIG. 4). Accordingly, the actual performance and the expected performance may be processed to generate a reward according to reinforcement learning processing.

For example, a difference between the actual performance and the expected performance may be determined. In some instances, the difference may further be compared to a predetermined threshold, where it is determined that a reward is incurred when the difference does not exceed the predetermined threshold. As another example, a reward need not be binary but may instead be dependent on the degree to which expected performance and actual performance differ. In other instances, the actual performance and the expected performance may each comprise multiple metrics, such that the reward generated at operation 506 is based on processing each expected performance metric in view of each actual performance metric. Example metrics include, but are not limited to, dropped packets, throughput, and/or signal strength.

Flow progresses to operation 508, where a RAN resource allocation is generated based on the reward and the performance information. For example, the reward generated at operation 506 may be used to tune a forecasting engine such that future forecasts account for forecasting performance of the historical performance information that was processed at operation 506. As described above, the RAN resource allocation may be generated based on a set of service-level guarantees associated with one or more slices of the RAN. Expected slice characteristics may be generated based on the RAN resource allocation, such that they may be evaluated during subsequent iterations of method 500, for example as the expected performance described above with respect to operation 506.

At operation 510, the RAN resource allocation is implemented in the RAN. For example, operation 510 may comprise communicating with one or more RAN components (e.g., as described above with respect to FIG. 1 and/or RAN components 404 in FIG. 4) to configure resources according to the RAN resource allocation.

An arrow is illustrated from operation 510 to operation 504 to indicate that flow may loop between operations 504-510, thereby dynamically configuring RAN resources according to the reinforcement learning techniques described herein. In examples, method 500 is performed on a frame-by-frame basis, where a RAN resource configuration is generated and implemented for each frame of the RAN. As another examples, method 500 may be performed in batches (e.g., such that operation 510 comprises providing an indication of a set of RAN resource allocations for multiple frames) or may be performed in response to one or more events, among other examples. Method 500 may eventually terminate at operation 512.

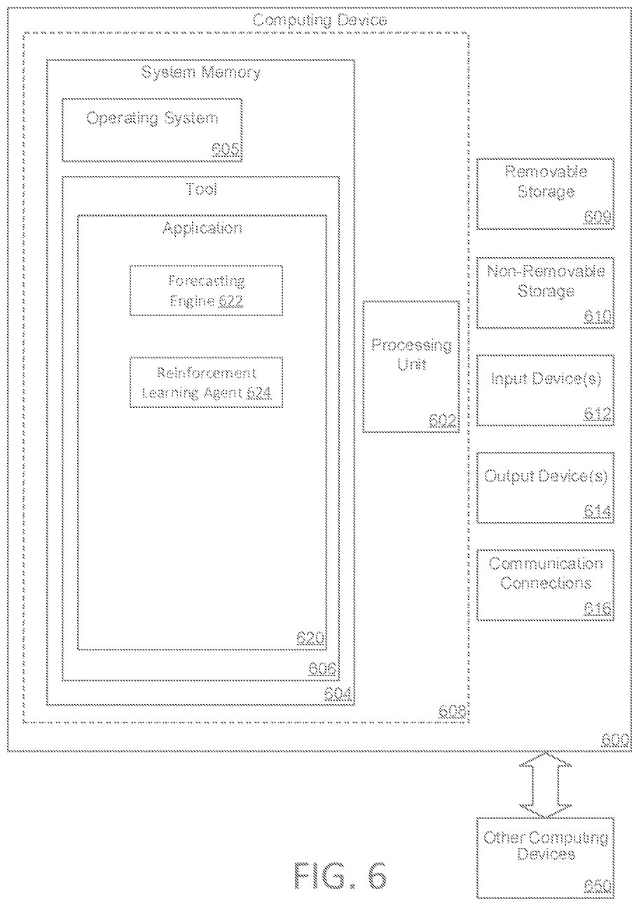

FIG. 6 is a block diagram illustrating physical components (e.g., hardware) of a computing device 600 with which aspects of the disclosure may be practiced. The computing device components described below may be suitable for the computing devices described above. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program tools 606 suitable for performing the various aspects disclosed herein such. The operating system 605, for example, may be suitable for controlling the operation of the computing device 600. Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program tools and data files may be stored in the system memory 604. While executing on the at least one processing unit 602, the program tools 606 (e.g., an application 620) may perform processes including, but not limited to, the aspects, as described herein. The application 620 includes a forecasting engine 622 and a reinforcement learning agent 624, aspects of which are described in more detail with regard to at least FIGS. 4 and 5. Other program tools that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units, and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 600 may also have one or more input device(s) 612, such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of the communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program tools. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program tools, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

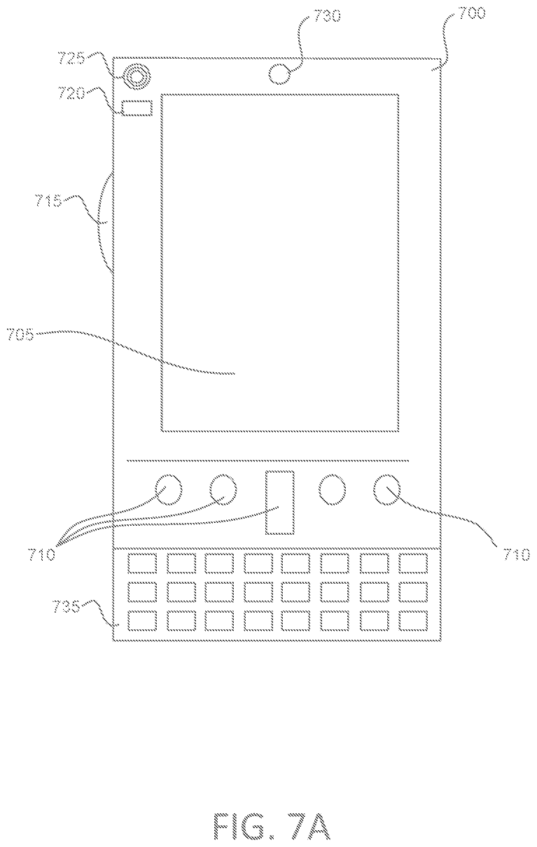

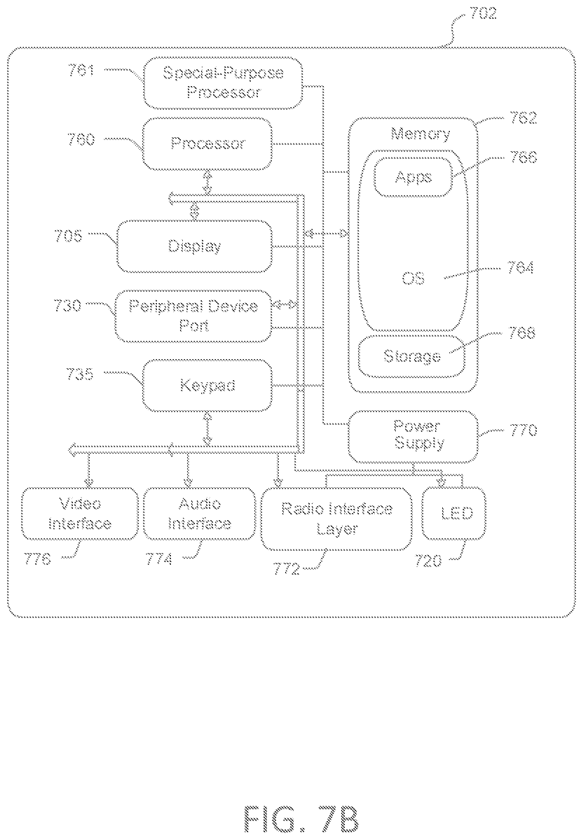

FIGS. 7A and 7B illustrate a computing device or mobile computing device 700, for example, a mobile telephone, a smart phone, wearable computer (such as a smart watch), a tablet computer, a laptop computer, and the like, with which aspects of the disclosure may be practiced. In some aspects, the client utilized by a user (e.g., as an operator of servers in the far-edge data center in FIG. 1) may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included as an optional input element, a side input element 715 allows further user input. The side input element 715 may be a rotary switch, a button, or any other type of manual input element. In alternative aspects, mobile computing device 700 may incorporate more or less input elements. For example, the display 705 may not be a touch screen in some aspects. In yet another alternative aspect, the mobile computing device 700 is a portable phone system, such as a cellular phone. The mobile computing device 700 may also include an optional keypad 735. Optional keypad 735 may be a physical keypad or a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of computing device, a server (e.g., the RAN servers 116 and the servers 134, and other servers as shown in FIG. 1), a mobile computing device, etc. That is, the mobile computing device 700 can incorporate a system 702 (e.g., a system architecture) to implement some aspects. The system 702 can implemented as a “smart phone” capable of running one or more applications (e.g., browser, e-mail, calendaring, contact managers, messaging clients, games, and media clients/players). In some aspects, the system 702 is integrated as a computing device, such as an integrated digital assistant (PDA) and wireless phone.

One or more application programs 766 may be loaded into the memory 762 and run on or in association with the operating system 764. Examples of the application programs include phone dialer programs, e-mail programs, information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700 described herein.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 (e.g., LED) may be used to provide visual notifications, and/or an audio interface 774 may be used for producing audible notifications via the audio transducer 725. In the illustrated configuration, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

As will be understood from the foregoing disclosure, one aspect of the technology relates to a system comprising: at least one processor; and memory storing instructions that, when executed by the at least one processor, causes the system to perform a set of operations. The set of operations comprises: determining a first resource allocation for a set of resources of a radio access network (RAN); determining, based on the first resource allocation, a set of expected slice characteristics for a first RAN slice and a second RAN slice; configuring the RAN according to the first resource allocation, thereby forming the first RAN slice comprising a first set of logical resources and forming the second RAN slice comprising a second set of logical resources; determining a set of actual slice characteristics based on historical performance of the RAN associated with the first resource allocation; determining, based on the set of expected slice characteristics and the set of actual slice characteristics, a second resource allocation for the set of resources of the RAN; and configuring the RAN according to the second resource allocation for the first RAN slice and the second RAN slice. In an example, the set of resources of the RAN is associated with a local scheduler of the first RAN slice to allocate the first set of logical resources among a set of devices associated with the first RAN slice. In another example, the historical performance of the RAN comprises channel state information associated with a radio unit of the RAN and slice-specific performance information for at least one of the first RAN slice and the second RAN slice. In a further example, determining the second resource allocation for the set of resources of the RAN comprises: evaluating the set of expected slice characteristics and the set of actual slice characteristics to generate a reward associated with the first resource allocation; and allocating, based on the generated reward, the set of resources of the RAN to generate the second resource allocation. In yet another example, the first resource allocation comprises an indication of at least one of: a resource block allocation; a time slot allocation; a numerology allocation; or a multiple-input and multiple-output (MIMO) layer allocation. In a further still example, the first resource allocation is for a first frame of the RAN and the second resource allocation is for a frame after the first frame. In an example, the first RAN slice is a low-latency network and the second RAN slice is a mobile broadband network.

In another aspect, the technology relates to a method for allocating resources of a radio access network (RAN) using reinforcement learning. The method comprises: generating a reward for a first resource allocation based on: a set of expected characteristics associated with the first resource allocation; and a set of actual characteristics from historical performance information associated with the RAN configured according to the first resource allocation; determining, based on the reward and the historical performance information associated with the RAN, a second resource allocation for the resources of the RAN; and implementing the second resource allocation to provide a first RAN slice comprising a first set of logical resources and a second RAN slice comprising a second set of logical resources. In an example, determining the second resource allocation further comprises generating a second set of expected slice characteristics for the second resource allocation; and the method further comprises: based on the second set of expected slice characteristics and a set of actual slice characteristics associated with the second resource allocation, determining a third resource allocation for the set of resources of the RAN; and implementing the third resource allocation for the first RAN slice and the second RAN slice. In another example, the first resource allocation is for a first frame of the RAN, the second resource allocation is for a second frame after the first frame, and the third resource allocation is for a third frame after the second frame. In a further example, the resources of the RAN are associated with a local scheduler of the first RAN slice to allocate the first set of logical resources among a set of devices associated with the first RAN slice; and the second resource allocation is determined without an indication of a scheduling technique used by the local scheduler. In yet another example, the historical performance information comprises channel state information associated with a radio unit of the RAN and slice-specific performance information for at least one of the first RAN slice and the second RAN slice. In a further still example, the second resource allocation comprises an indication of at least one of: a resource block allocation; a time slot allocation; a numerology allocation; or a multiple-input and multiple-output (MIMO) layer allocation.

In a further aspect, the technology relates to a method for allocating resources of a radio access network (RAN) to form a first RAN slice and a second RAN slice. The method comprises: determining a first resource allocation for a set of resources of the RAN; determining, based on the first resource allocation, a set of expected slice characteristics for the first RAN slice and the second RAN slice; configuring the RAN according to the first resource allocation, thereby forming the first RAN slice comprising a first set of logical resources and forming the second RAN slice comprising a second set of logical resources; determining a set of actual slice characteristics based on historical performance of the RAN associated with the first resource allocation; determining, based on the set of expected slice characteristics and the set of actual slice characteristics, a second resource allocation for the set of resources of the RAN; and configuring the RAN according to the second resource allocation for the first RAN slice and the second RAN slice. In an example, the set of resources of the RAN is associated with a local scheduler of the first RAN slice to allocate the first set of logical resources among a set of devices associated with the first RAN slice. In another example, the historical performance of the RAN comprises channel state information associated with a radio unit of the RAN and slice-specific performance information for at least one of the first RAN slice and the second RAN slice. In a further example, determining the second resource allocation for the set of resources of the RAN comprises: evaluating the set of expected slice characteristics and the set of actual slice characteristics to generate a reward associated with the first resource allocation; and allocating, based on the generated reward, the set of resources of the RAN to generate the second resource allocation. In yet another example, the first resource allocation comprises an indication of at least one of: a resource block allocation; a time slot allocation; a numerology allocation; or a multiple-input and multiple-output (MIMO) layer allocation. In a further still example, the first resource allocation is for a first frame of the RAN and the second resource allocation is for a frame after the first frame. In another example, the first RAN slice is a low-latency network and the second RAN slice is a mobile broadband network.

What is claimed is:

1. A system comprising:
at least one processor; and
memory storing instructions that, when executed by the at least one processor, causes the system to perform a set of operations, the set of operations comprising:
determining a first resource allocation for a set of resources of a radio access network (RAN);
determining, based on the first resource allocation, a set of expected slice characteristics for a first RAN slice and a second RAN slice;
configuring the RAN according to the first resource allocation, thereby forming the first RAN slice comprising a first set of logical resources and forming the second RAN slice comprising a second set of logical resources;
determining a set of actual slice characteristics based on historical performance of the RAN associated with the first resource allocation;
determining, based on the set of expected slice characteristics and the set of actual slice characteristics, a second resource allocation for the set of resources of the RAN; and
configuring the RAN according to the second resource allocation for the first RAN slice and the second RAN slice.

2. The system of claim 1, wherein the set of resources of the RAN is associated with a local scheduler of the first RAN slice to allocate the first set of logical resources among a set of devices associated with the first RAN slice.

3. The system of claim 1, wherein the historical performance of the RAN comprises channel state information associated with a radio unit of the RAN and slice-specific performance information for at least one of the first RAN slice and the second RAN slice.

4. The system of claim 1, wherein determining the second resource allocation for the set of resources of the RAN comprises:
evaluating the set of expected slice characteristics and the set of actual slice characteristics to generate a reward associated with the first resource allocation; and
allocating, based on the generated reward, the set of resources of the RAN to generate the second resource allocation.

5. The system of claim 1, wherein the first resource allocation comprises an indication of at least one of:
a resource block allocation;
a time slot allocation;
a numerology allocation; or
a multiple-input and multiple-output (MIMO) layer allocation.

6. The system of claim 1, wherein the first resource allocation is for a first frame of the RAN and the second resource allocation is for a frame after the first frame.

7. The system of claim 1, wherein the first RAN slice is a low-latency network and the second RAN slice is a mobile broadband network.

8. A method for allocating resources of a radio access network (RAN) using reinforcement learning, comprising:
generating a reward for a first resource allocation based on:
a set of expected characteristics associated with the first resource allocation; and
a set of actual characteristics from historical performance information associated with the RAN configured according to the first resource allocation;
determining, based on the reward and the historical performance information associated with the RAN, a second resource allocation for the resources of the RAN; and
implementing the second resource allocation to provide a first RAN slice comprising a first set of logical resources and a second RAN slice comprising a second set of logical resources.

9. The method of claim 8, wherein:
determining the second resource allocation further comprises generating a second set of expected slice characteristics for the second resource allocation; and
the method further comprises:
based on the second set of expected slice characteristics and a set of actual slice characteristics associated with the second resource allocation, determining a third resource allocation for the set of resources of the RAN; and
implementing the third resource allocation for the first RAN slice and the second RAN slice.

10. The method of claim 9, wherein the first resource allocation is for a first frame of the RAN, the second resource allocation is for a second frame after the first frame, and the third resource allocation is for a third frame after the second frame.

11. The method of claim 8, wherein:
the resources of the RAN are associated with a local scheduler of the first RAN slice to allocate the first set of logical resources among a set of devices associated with the first RAN slice; and
the second resource allocation is determined without an indication of a scheduling technique used by the local scheduler.

12. The method of claim 8, wherein the historical performance information comprises channel state information associated with a radio unit of the RAN and slice-specific performance information for at least one of the first RAN slice and the second RAN slice.

13. The method of claim 8, wherein the second resource allocation comprises an indication of at least one of:
a resource block allocation;
a time slot allocation;
a numerology allocation; or
a multiple-input and multiple-output (MIMO) layer allocation.

14. A method for allocating resources of a radio access network (RAN) to form a first RAN slice and a second RAN slice, the method comprising:
determining a first resource allocation for a set of resources of the RAN;
determining, based on the first resource allocation, a set of expected slice characteristics for the first RAN slice and the second RAN slice;
configuring the RAN according to the first resource allocation, thereby forming the first RAN slice comprising a first set of logical resources and forming the second RAN slice comprising a second set of logical resources;
determining a set of actual slice characteristics based on historical performance of the RAN associated with the first resource allocation;
determining, based on the set of expected slice characteristics and the set of actual slice characteristics, a second resource allocation for the set of resources of the RAN; and
configuring the RAN according to the second resource allocation for the first RAN slice and the second RAN slice.

15. The method of claim 14, wherein the set of resources of the RAN is associated with a local scheduler of the first RAN slice to allocate the first set of logical resources among a set of devices associated with the first RAN slice.

16. The method of claim 14, wherein the historical performance of the RAN comprises channel state information associated with a radio unit of the RAN and slice-specific performance information for at least one of the first RAN slice and the second RAN slice.

17. The method of claim 14, wherein determining the second resource allocation for the set of resources of the RAN comprises:
evaluating the set of expected slice characteristics and the set of actual slice characteristics to generate a reward associated with the first resource allocation; and
allocating, based on the generated reward, the set of resources of the RAN to generate the second resource allocation.

18. The method of claim 14, wherein the first resource allocation comprises an indication of at least one of:
a resource block allocation;
a time slot allocation;
a numerology allocation; or
a multiple-input and multiple-output (MIMO) layer allocation.

19. The method of claim 14, wherein the first resource allocation is for a first frame of the RAN and the second resource allocation is for a frame after the first frame.

20. The method of claim 14, wherein the first RAN slice is a low-latency network and the second RAN slice is a mobile broadband network.
